(19) United States
(12) Patent Application Publication
(10) Pub. No.: US 2008/0152773 A1
(43) Pub. Date: Jun. 26, 2008

(54) Apparatus, system, and method for steeping

(76) Inventor: Allison Leber, Chicago, IL (US)

Correspondence Address: JENNER & BLOCK, LLP, ONE IBM PLAZA, CHICAGO, IL, 60611, US

(21) Appl. No.: 11/645,424

(22) Filed: Dec. 26, 2006

(51) Int. Cl. A23F 3/36; A47J 31/18

(52) U.S. Cl. 426/435; 99/289 R

(57) ABSTRACT

An apparatus for handling a substance to be steeped includes a clip, a tray and a connector attaching the clip to the tray. The substance to be steeped, or pouch containing such substance, is attached to the clip and placed into a vessel, with the connector supported by the rim of the vessel and the tray remaining outside the vessel. A user can remove the substance/pouch from the vessel and manipulate it onto the tray by grasping and manipulating the tray and/or the connector, without using any other device.

### FIELD OF THE INVENTION

The present invention relates to apparatus, systems, and methods for facilitating steeping, for example, apparatus, systems, and methods for facilitating the use of a tea bag in connection with a brewing vessel and temporary storage of a used tea bag prior to re-use or disposal.

### BACKGROUND OF THE INVENTION

Tea consumption dates back thousands of years. According to legend, around 2737 B.C., Emperor Shen Nung was preparing his customary drink of boiled water when leaves from an overhanging tea tree accidentally fell into the kettle. The result was a brew that quickly gained popularity, reaching into every aspect of Chinese society and eventually spreading outside of China to Japan and then Europe. It was the Dutch who surfaced as Europe's preeminent Oriental traders when the defeat of the Spanish Armada in 1588 ended Portuguese and Spanish dominance of the commercial routes. And it was the Dutch who decided there might be a guilder or two to be earned in tea. In 1637 the Dutch East India Company added tea to its list of regularly traded goods. Tea drinking, with its rumored medicinal benefits, spread through Europe. Surprisingly, the British were the last to appreciate is charms, coffee being the fad of the day. But, with a tea-loving Portuguese queen in the palace of Charles II, tea drinking won the day, and the British East India Company began to import tea directly from China. Tea caught on in America as well, introduced by the Dutch in New Amsterdam, not by the British. Thrifty New Englanders even brought a new twist to tea consumption: they brewed their tea, then ate the spent leaves on toast with butter and salt.

Tea became embroiled in politics in the American colonies. Starting in 1767, the British government taxed tea imports in the colonies so heavily that colonists boycotted the British East India Company and turned to smuggled Dutch tea. It was an attempt to force British tea on the colonies that led to the dumping of 342 chests of tea into Boston Harbor on the night of Dec. 16, 1773. Tea consumption in America, not surprisingly, declined drastically during the Revolution. But by then, tea had already worked its magic on American tastes.

In 1908, Thomas Sullivan, a New York City tea importer, developed the concept of “bagged tea”. As a tea merchant, he carefully wrapped in small silk bags each sample delivered to potential customers for their consideration. He recognized a natural marketing opportunity when he learned that restaurants were brewing the samples in the bags to avoid messing up their kitchens with tea leaves. Although brewing tea “in the bag” made tea consumption more convenient, other problems remained, for example, the problems of extracting the tea bag from a cup once the desired strength has been reached and storing the tea bag tableside until disposal is convenient. One effort to solve the former problem includes connecting a tag of paper or light card stock to one end of a string and the tea bag to the other end of the string. This arrangement allows a user to lower a tea bag into, and remove the bag from, a brewing vessel, for example, a tea cup, by handling only the tag. While the tea is brewing, the string and tag typically would be draped over the rim of the vessel to keep the tag out of the brew. This solution is imperfect, however, because such strings and tags typically are flimsy and lightweight and fall or are drawn into the vessel, requiring the user to fish them out. Also, such strings and tags typically are unaesthetic. Further, many brands of tea bags are not available with such strings and tags whatsoever. Moreover, such strings and tags alone do not solve the latter problem of storing the tea bag after the tea has been brewed to the desired strength but before the bag can be reused or conveniently disposed of. Users typically end up setting the used bag on a saucer or bread plate, resulting in a soiled cup bottom or soggy breads or pastries. If such plates are not available, users may have no choice but to deposit the used tea bag on a nearby tabletop or counter, creating an even greater mess.

### BRIEF DESCRIPTION OF THE DRAWINGS

FIG. 1 is a pictorial diagram illustrating an embodiment of an apparatus and system according to the present invention;

FIG. 2 is a pictorial diagram illustrating an embodiment of an apparatus and system according to the present invention;

FIG. 3 is a pictorial diagram illustrating an embodiment of an apparatus and system according to the present invention;

FIG. 4 is a pictorial diagram illustrating an embodiment of an apparatus and system according to the present invention;

FIG. 5 is a pictorial diagram illustrating an embodiment of an apparatus and system according to the present invention;

FIG. 6 is a pictorial diagram illustrating an embodiment of an apparatus and system according to the present invention;

FIG. 7 is a pictorial diagram illustrating a portion of an apparatus according to the present invention; and

FIG. 8 is a pictorial diagram illustrating a portion of an apparatus according to the present invention.

### DETAILED DESCRIPTION OF THE ILLUSTRATED EMBODIMENTS

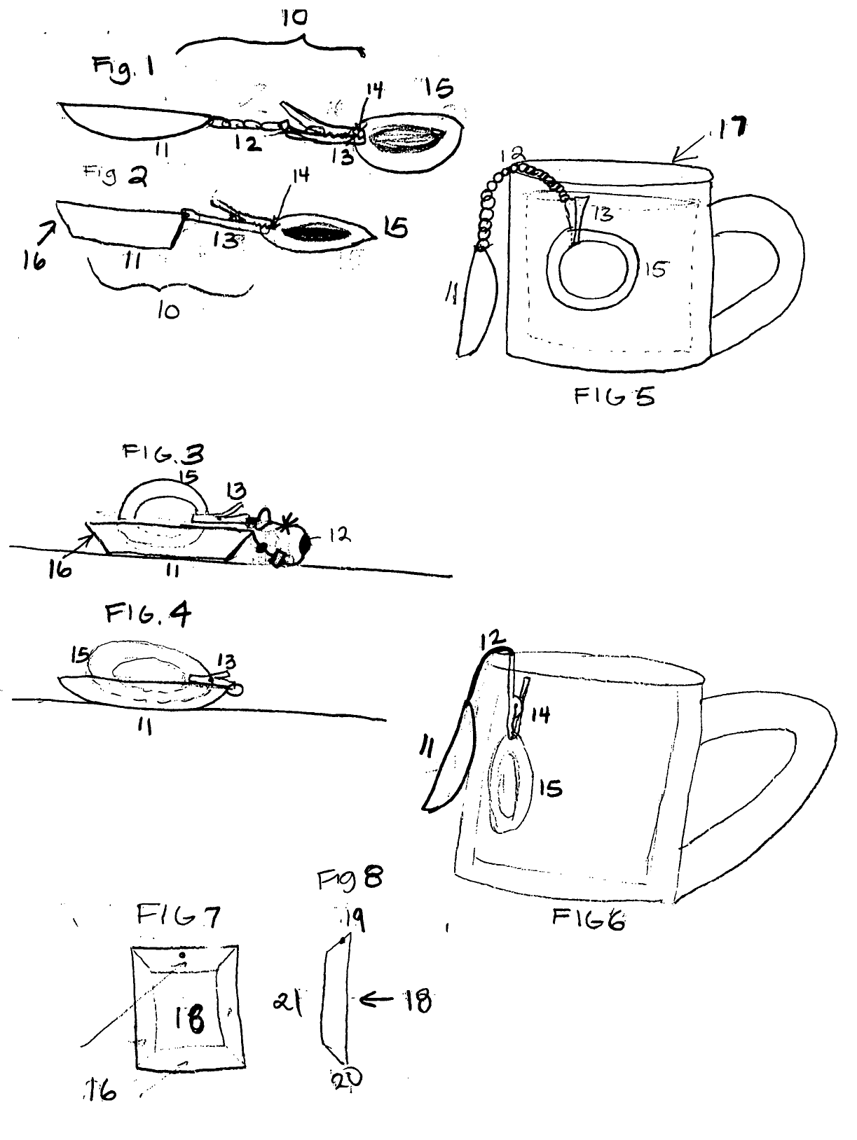

FIG. 1 illustrates a preferred embodiment of an apparatus 10 in accordance with the present invention. Apparatus 10 includes clip 13, tray 11, and tether 12 connecting clip 13 to tray 11. Clip 13 can be any form of clip capable of grasping a tea bag, for example, tea bag 15. Preferably, clip 13 includes grasping surfaces 14 having teeth, texture, or sufficient roughness to securely grasp a tea bag, even when clip 13 and tea bag 15 are wet. Suitable forms of clips include, but are limited to, alligator clips, clothespin-style clips, paper clips, and spring-steel binder clips. Preferably, clip 13 is made of one or more materials that will not rust, corrode, or otherwise adversely react when exposed to hot water, tea, or detergents. Preferably, clip 13 is made of a suitable grade of stainless steel, wood, plastic, or combination thereof. Many other materials could be used, as well, as would be recognized by one skilled in the art.

Tray 11 can be any form of device that can support a tea bag. In preferred embodiments, tray 11 is capable of containing liquid that may drip from or leach out of a wet tea bag. Tray 11 can take a wide variety of sizes and shapes. Preferably, tray 11 is shaped to contain a liquid thereon. For example, tray 11 may be bowl-shaped, as shown in FIGS. 1, 4, 5 and 6. Alternatively, tray 11 can include a substantially planar portion and an upturned perimeter which forms a liquid-containing sidewall or rim 16, as shown in FIGS. 2, 3, 7 and 8. Many other configurations are possible, as would be recognized by one skilled in the art. Alternatively, tray 11 could be made in whole or in part of a material capable of absorbing an amount of liquid that might be expected to drip from or leach out of a wet tea bag after it has been used to brew tea or otherwise immersed in a liquid. Preferably, tray 11 is made of one or more materials that will not rust, corrode, or otherwise adversely react when exposed to hot water, tea, or detergents. Suitable materials include, without limitation, plastic, rubber, metal, clay, stone, porcelain, glass, wood, sponge, or combinations thereof. Many other materials could be used, as well, as would be recognized by one skilled in the art. Tray 11 can be decorated in any variety of ways. For example, tray 11 can be painted, coated, and/or adorned with monograms, designs, images, inlays, photographs, and the like, as desired. In embodiments where tray 11 is decorated, the materials used for decoration preferably will not rust, corrode, dissolve, bleed, or otherwise adversely react when exposed to hot water, tea, or detergents.

Tether 12 can be any form of device capable of connecting clip 13 to tray 11. Preferably, tether 12 is sufficiently flexible to allow clip 13 (with or without tea bag 15 attached thereto) to be moved freely with respect to tray 11. Tether 12 can be a unitary cord, as shown in FIG. 6 or a chain of interconnected elements, as shown in FIGS. 1, 3 and 5. In the FIG. 1 embodiment, tether 12 is a simple chain of similar linked elements or beaded chain. In the FIG. 3 embodiment, tether 12 is a more complex chain including beads, jewels, or other charms. In the FIG. 5 embodiment, tether 12 is a simple beaded chain. Tether 12 can be embodied in any number of other suitable ways, as would be recognized by one skilled in the art. Preferably, tether 12 is made of one or more materials that will not rust, corrode, or otherwise adversely react when exposed to hot water, tea, or detergents.

Tether 12 can be connected to tray 11 by permanent bonding, soldering or welding or other means of permanent attachment. Alternatively, tether 12 can be attached to tray 11 in such a manner that tray 11 can be readily disconnected from and re-connected to tether 12. Similarly, tether 12 can be connected to clip 13 by permanent bonding, soldering or welding or other means of permanent attachment, or tether 12 can be attached to clip 13 in such a way that clip 13 can be readily disconnected from and re-connected to tether 12 as desired by the user. In embodiments wherein tether 12 is removable from tray 11 and/or clip 13 as described above, a user can readily exchange clips, tethers and/or trays to suit the user's preference or tailor apparatus 10 for various uses.

Tether 12 can be of any suitable length as dictated by the intended use, the designer's preference, and/or the user's preference. In some embodiments, tether 12 may be relatively short, as shown in FIG. 1. In other embodiments, tether 12 can be omitted altogether. In such embodiments, clip 13 preferably is hinged to tray 11, as shown in FIGS. 2 and 4. In yet other embodiments, tether 12 can be substantially longer, as shown in FIG. 5.

A user could use apparatus 10 brew a cup of tea according to a preferred method of using the present invention by attaching clip 13 to tea bag 15, lowering tea bag 15 into cup 17 (preferably while holding apparatus 10 by tray 11 or tether 12), and draping tether 12 over the rim of cup 17 such that tray 11 hangs or otherwise remains outside cup 17. In embodiments lacking tether 12, the user preferably would position the hinged connection between tray 11 and clip 13 about the rim of cup 17 such that clip 13 and tea bag 15 would hang inside cup 17 and tray 11 would hang or otherwise remain outside cup 17. Once the tea has reached the desired strength, the user preferably would grasp tray 11 and/or tether 12 to remove tea bag 15 from cup 17 and manipulate tea bag 15 onto tray 11 for temporary storage of tea bag 15 prior to its re-use or disposal. No other device would be required for handling or temporarily storing tea bag 15.

Preferably, apparatus 10 is used in connection with tea bags lacking an integral string and/or tag. However, apparatus 10 could be used in connection with tea bags having integral strings and/or tags by attaching clip 13 directly to such tea bag or to its integral string and/or tag and draping tether 12 and/or such integral string/and/or tag over the rim of cup 17.

An appropriately designed and sized apparatus 10 could be used to brew a pot of hot tea or a jar of iced tea in a similar manner, as would be recognized by one skilled in the art. One skilled in the art would recognize that apparatus 10 also could be used to brew other beverages. For example, apparatus 10 could be used to brew coffee provided in filter bags or pods. Further, apparatus 10 could be used in cooking, for example, to immerse a bouquet garni into a simmering liquid and easily remove it once the desired essence has been transferred. The used bouquet garni could be temporarily stored in tray 11 and/or tray 11 could be used to facilitate disposal of the used bouquet garni without dripping liquid onto the stove, kitchen counter, or floor.

Although the present invention has been described with reference to certain preferred embodiments, those skilled in the art will recognize that changes may be made in form and detail without departing from the spirit and scope of the invention.

I claim:

1. An apparatus for handling a substance to be steeped, comprising:
a clip adapted to grasp said substance;
a connector attached to said clip; and
a tray attached to said connector, said tray adapted to support said substance.

2. The apparatus of claim 1 wherein said connector comprises a hinge.

3. The apparatus of claim 1 wherein said connector comprises a tether.

4. The apparatus of claim 3 wherein said tether comprises a cord.

5. The apparatus of claim 3 wherein said tether comprises a chain.

6. The apparatus of claim 3 wherein said tether is removable from at least one of said clip and said tray.

7. The apparatus of claim 1 wherein said tray is decorated.

8. The apparatus of claim 1 wherein said tray is configured to retain a liquid thereon.

9. A system for steeping, comprising:
a pouch containing a substance to be steeped;
a clip removably attached to said pouch;
a connector attached to said clip;
a tray attached to said connector.

10. A method for steeping, comprising the step of:
attaching a clip to a pouch containing a substance to be steeped;
attaching a tray to said clip;
immersing said pouch in a liquid;
removing said pouch from said liquid;
manipulating said pouch onto said tray;
wherein said steps of removing and manipulating are performed by a user using only said clip and said tray.

11. The method of claim 10 wherein said tray is attached to said clip using a connector and wherein said steps of removing and manipulating are performed by a user using only said clip, said tray, and said connector.

12. The method of claim 11 wherein said connector comprises a tether.
